(19) United States
(12) Patent Application Publication
(10) Pub. No.: US 2013/0107178 A1
(43) Pub. Date: May 2, 2013

(54) LIQUID CRYSTAL DISPLAY DEVICE

(71) Applicant: Wintek Corporation, Taichung City (TW)

(72) Inventors: Hsien-Wei Chiang, Taipei City (TW); Kuan-Hsien Wu, Changhua County (TW)

(73) Assignee: WINTEK CORPORATION, Taichung City (TW)

(21) Appl. No.: 13/661,057

(22) Filed: Oct. 26, 2012

(30) Foreign Application Priority Data
Nov. 2, 2011 (TW) 100139934

(51) Int. Cl. G02F 1/1335

(52) U.S. Cl. 349/104

(57) ABSTRACT

A liquid crystal display device includes a first substrate, a second substrate, a first electrode, a second electrode, a plurality of transmittance controlling units, and a plurality of liquid crystal pixel units. The first substrate and the second substrate are disposed oppositely to each other. The first electrode is disposed on the first substrate, and the second electrode is disposed on the second substrate. Each of the transmittance controlling units is disposed between the first electrode and the second electrode. At least two of the transmittance controlling units have different light transmittances. Each of the liquid crystal pixel units is disposed correspondingly to one of the transmittance controlling units. The liquid crystal pixel units corresponding to the transmittance controlling units with different light transmittances are employed to reflect light within different wavelength ranges.

### BACKGROUND OF THE INVENTION

1. Field of the Invention

The present invention relates to a liquid crystal display device, and more particularly, to a liquid crystal display device with transmittance controlling units, which are applied in an exposure process for making each of the liquid crystal pixel units in the liquid crystal display device capable of reflecting light within a wavelength range and allowing light beyond the wavelength range to pass through.

2. Description of the Prior Art

Compact designs and low power consumptions may be realized in reflective liquid crystal display devices because backlight units are not required for the reflective liquid crystal display. Among all kinds of liquid crystals, the cholesteric liquid crystal is suitable for the low power consumption reflective liquid crystal display device because the cholesteric liquid crystal may be employed to selectively reflect light within a wavelength range and kept in a bistable state when applied voltages are removed.

In ordinary single layer cholesteric liquid crystal color display technique, processes such as inkjet printing or pixelized vacuum filling (PVF) may be employed to fill the panel with non-photoreactive cholesteric liquid crystal materials, which are capable of selectively reflecting light within different wavelength ranges. However, the equipment cost of inkjet printing is relatively expensive and additional cutting processes of PVF still suffer many problems. Photoreactive cholesteric liquid crystal materials are therefore developed for single layer cholesteric liquid crystal color display devices by applying different ultraviolet exposure energies to the photoreactive cholesteric liquid crystal materials. For further describing the method of manufacturing the single layer cholesteric liquid crystal color display device with the photoreactive cholesteric liquid crystal material, please refer to FIG. 1 and FIG. 2. As shown in FIG. 1 and FIG. 2, a conventional single layer cholesteric liquid crystal color display device 500 includes a first substrate 510, a second substrate 520, a first electrode 530, a second electrode 540, an adhesive layer 580, a plurality of spacers 570, and a plurality of liquid crystal pixel units 560. The first substrate 510 has a first inner surface 511 and a first outer surface 512. The second substrate 520 is disposed oppositely to the first substrate 510. The second substrate 520 has a second inner surface 521 and a second outer surface 522. The second inner surface 521 faces the first inner surface 511. The first electrode 530 and the second electrode 540 are respectively disposed on the first inner surface 511 and the second inner surface 521. The adhesive layer 580 is disposed between the first electrode 530 and the second electrode 540. The adhesive layer is employed to combine the first substrate 510 and the second substrate 520. The spacers 570 are disposed between the first electrode 530 and the adhesive layer 580 to form a plurality of flow channels 571. A plurality of liquid crystal pixel units 560 may then be formed by filling each of the flow channels 571 with identical cholesteric liquid crystal monomers and other materials such as dyes or chiral reagents. To simplify the filling process of the liquid crystal pixel units 560 and make the adjacent liquid crystal pixel units 560 capable of reflecting light within different wavelength ranges for presenting a color display effect, all of the flow channels 571 are filled with a liquid crystal material capable of reflecting light within a specific wavelength range first, and different exposure energies are applied to the adjacent liquid crystal pixel units 560 to modify the properties of reflecting light. As shown in FIG. 1, a first photomask 591 is used in a first exposure process 593 to apply an exposure dose to some of the liquid crystal pixel units 560. Subsequently, as shown in FIG. 2, a second photomask 592 is used in a second exposure process 594 to apply another exposure dose to some of the liquid crystal pixel units 560 which have been exposed by the first exposure process 593. By modifying the exposure doses of the first exposure process 593 and the second exposure process 594, the adjacent liquid crystal pixel units 560 may be capable of reflecting light within different wavelength ranges, and the reflecting light from each of the liquid crystal pixel units 560 may be mixed to present a full color display effect. However, more exposure processes and more photomasks are required in the above-mentioned method of manufacturing the conventional single layer cholesteric liquid crystal color display device. Problems, such as the exposure process may be influenced by inadequately controlling distances between the photomask and the substrate or such as the exposure process may be influenced by the variation in the transmittance of the substrate may then be aggravated.

### SUMMARY OF THE INVENTION

It is one of the objectives of the present invention to provide a liquid crystal display device. Transmittance controlling units are disposed in the liquid crystal display device. The transmittance controlling units are treated with a single exposure process to make each of the liquid crystal pixel units capable of reflecting light within different wavelength ranges and presenting a reflective type full color display effect.

To achieve the purposes described above, a preferred embodiment of the present invention provides a liquid crystal display device. The liquid crystal display device includes a first substrate, a second substrate, a first electrode, a second electrode, a plurality of transmittance controlling units, and a plurality of liquid crystal pixel units. The first substrate has a first inner surface and a first outer surface. The second substrate is disposed oppositely to the first substrate. The second substrate has a second inner surface and a second outer surface, and the second inner surface faces the first inner surface. The first electrode is disposed on the first inner surface of the first substrate, and the second electrode is disposed on the second inner surface of the second substrate. The transmittance controlling units are disposed between the first substrate and the second substrate. At least two of the transmittance controlling units have different light transmittances. The liquid crystal pixel units are disposed between the transmittance controlling units and the second electrode, and each of the liquid crystal pixel units is disposed correspondingly to one of the transmittance controlling units. The liquid crystal pixel units corresponding to the transmittance controlling units with different light transmittances are employed to reflect light within different wavelength ranges.

In the liquid crystal display device of the present invention, the transmittance controlling units provide a function similar to the photomask in the conventional art, and the transmittance controlling units are treated with the exposure process to modify the wavelength range of the light reflected by the liquid crystal pixel unit. Each of the transmittance controlling units may be designed with different light transmittances to make each of the liquid crystal pixel units capable of reflecting different colors and the liquid crystal display device may then present the full color display effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating a method of manufacturing a conventional single layer cholesteric liquid crystal color display device.

FIG. 3 is a schematic diagram illustrating a liquid crystal display device according to a first preferred embodiment of the present invention.

FIG. 4 is a schematic diagram illustrating a method of manufacturing a liquid crystal display device according to a first preferred embodiment of the present invention.

FIG. 5 is a schematic diagram partially illustrating a top view of a liquid crystal display device according to a first preferred embodiment of the present invention.

FIG. 6 is a schematic diagram partially illustrating a top view of a liquid crystal display device according to another preferred exemplary embodiment of the present invention.

FIG. 7 is a schematic diagram illustrating a liquid crystal display device according to a second preferred embodiment of the present invention.

FIG. 8 is a schematic diagram illustrating a liquid crystal display device according to a third preferred embodiment of the present invention.

FIG. 9 is a schematic diagram illustrating a liquid crystal display device according to a fourth preferred embodiment of the present invention.

FIG. 10 is a schematic diagram illustrating a liquid crystal display device according to a fifth preferred embodiment of the present invention.

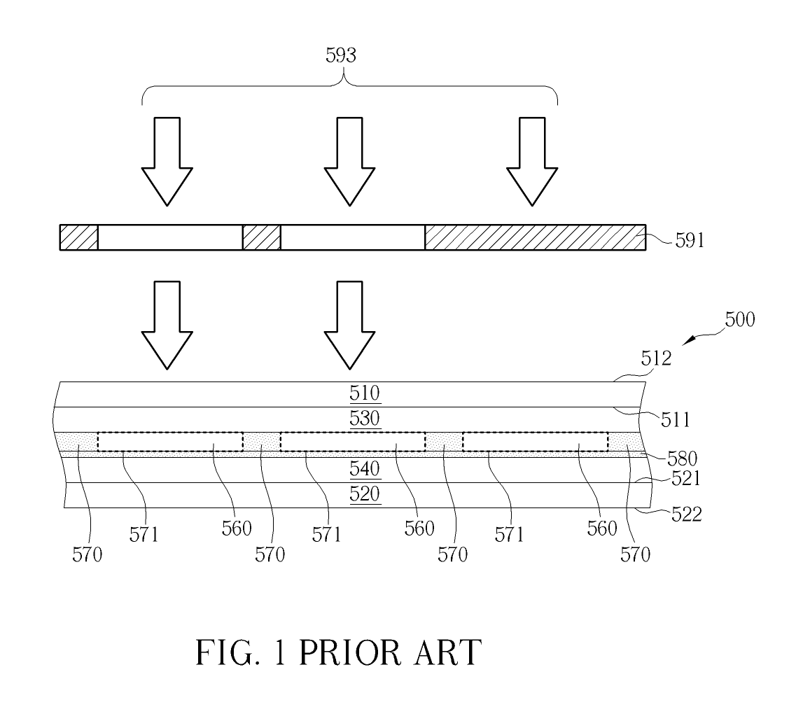

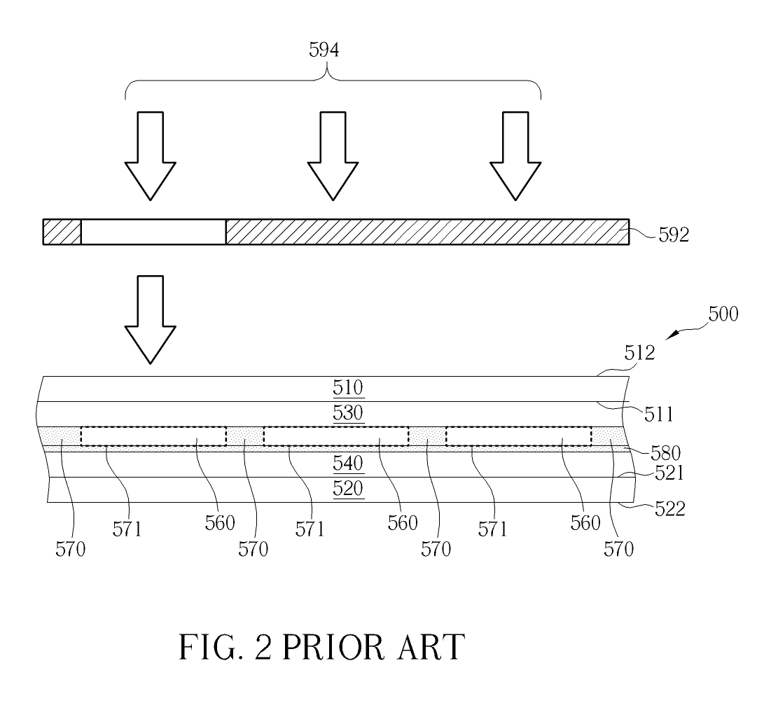

### DETAILED DESCRIPTION

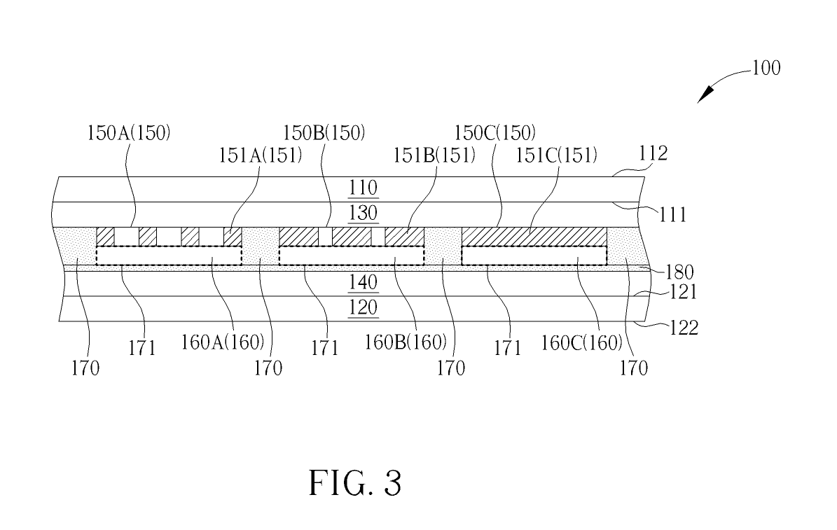

Please refer to FIG. 3. FIG. 3 is a schematic diagram illustrating a liquid crystal display device according to a first preferred embodiment of the present invention. Please note that the figures are only for illustration and the figures may not be to scale. The scale may be further modified according to different design considerations. As shown in FIG. 3, a liquid crystal display device 100 includes a first substrate 110, a second substrate 120, a first electrode 130, a second electrode 140, a plurality of transmittance controlling units 150, a plurality of liquid crystal pixel units 160, and a plurality of spacers 170. Each of the liquid crystal pixel units is employed to reflect light within a wavelength range and allow light beyond the wavelength range to pass through and the liquid crystal display device 100 may then present a reflective type display effect. The first substrate 110 has a first inner surface 111 and a first outer surface 112. The second substrate 120 is disposed oppositely to the first substrate 110. The second substrate 120 has a second inner surface 121 and a second outer surface 122, and the second inner surface 121 faces the first inner surface 111. In this embodiment, the first substrate 110 and second substrate 120 may include glass substrates, polyethylene terephthalate (PET) substrates, polyethersulfone (PES) substrates, or polyimide (PI) substrates, but the present invention is not limited to this and substrates made of other appropriate materials may also be employed as the first substrate 110 and second substrate 120 in the present invention. Additionally, the first electrode 130 is disposed on the first inner surface 111 of the first substrate 110, and the second electrode 140 is disposed on the second inner surface 121 of the second substrate 120. In this embodiment, the first electrode 130 and the second electrode 140 may include a transparent conductive material such as indium tin oxide (ITO), indium zinc oxide (IZO), aluminum zinc oxide (AZO), zinc oxide, and tin oxide, but not limited thereto. The transmittance controlling units 150 are disposed between the first substrate 110 and the second substrate 120. In this embodiment, the transmittance controlling units 150 are preferably disposed between the first electrode 130 and the second electrode 140, but the present invention is not limited to this and the transmittance controlling units 150 may also be disposed between the first substrate 110 and the first electrode 130 in other preferred embodiments for lowering driving voltage of the liquid crystal pixel units 160. The spacers 170 are disposed between the first electrode 130 and the second electrode 140 to form a plurality of flow channel 171. In this embodiment, the spacers 170 may include epoxy material, acrylic material, or other appropriate medium materials, and the spacers 170 may be formed by a printing process, a lithographic process, or other appropriate processes. In addition, a height of the spacer 170 is preferably less than or equal to 30 micrometers in order to control a size of the flow channel 171, but not limited thereto.

In this embodiment, each of the transmittance controlling units 150 is disposed in each of the flow channels 171, but the present invention is not limited to this and each of the transmittance controlling units 150 may be partially disposed between the spacer 170 and the first electrode 130. Additionally, at least two of the transmittance controlling units 150 have different light transmittances. The liquid crystal pixel units 160 are disposed between the transmittance controlling units 150 and the second electrode 140, and each of the liquid crystal pixel units 160 is disposed correspondingly to one of the transmittance controlling units 150. The liquid crystal pixel units 160 corresponding to the transmittance controlling units 150 with different light transmittances are employed to reflect light within different wavelength ranges. More specifically, in this embodiment, the transmittance controlling units 150 include at least one first transmittance controlling unit 150A, at least one second transmittance controlling unit 150B, and at least one third transmittance controlling unit 150C. The liquid crystal pixel units 160 include at least one first liquid crystal pixel unit 160A, at least one second liquid crystal pixel unit 160B, and at least one third liquid crystal pixel unit 160C. The first transmittance controlling unit 150A corresponds to the first liquid crystal pixel unit 160A, the second transmittance controlling unit 150B corresponds to the second liquid crystal pixel unit 160B, and the third transmittance controlling unit 150C corresponds to the third liquid crystal pixel unit 160C. A light transmittance of the first transmittance controlling unit 150A, a light transmittance of the second transmittance controlling unit 150B, and a light transmittance of the third transmittance controlling unit 150C are different from each other. The first liquid crystal pixel unit 160A, the second liquid crystal pixel unit 160B, and the third liquid crystal pixel unit 160C are respectively employed to reflect light within different wavelength ranges. It is worth noting that the present invention is not limited to the above condition, and the light transmittance of each of the transmittance controlling units may be further modified. For example, the transmittance controlling units 150 with two different light transmittances, four different light transmittances, or even more different light transmittances may be employed to generate the liquid crystal pixel units 160 capable of reflecting light within different wavelength ranges. In this embodiment, materials of the liquid crystal pixel unit may include a liquid crystal monomer, a dye, a chiral reagent, or a polymer compound, but not limited thereto. The liquid crystal monomer mentioned above may include a nematic liquid crystal monomer, a cholesteric liquid crystal monomer, or other liquid crystal materials capable of reflecting light within a wavelength range. Additionally, the chiral reagent mentioned above may include a cyano chiral reagent, a cholesteryl nonanoate chiral reagent, a non-racemic chiral reagent, a macromolecular helicity chiral reagent, an azobenzenes chiral reagent, a ZLI chiral reagent, a binaphthalene chiral, a dipolar chiral reagent, a SPE chiral reagent, or other appropriate chiral reagents. The polymer compound mentioned above may be optically solidified or thermally solidified, and the polymer compound may include a mono-functional monomer, a multi-functional monomer, a mono-functional oligomer, a multi-functional oligomer, a promoter, a curing agent, or other appropriate materials for optical solidification or thermal solidification. It is worth noting that each of the liquid crystal pixel units 160 is disposed in the flow channel 171, and each of the spacers 170 is disposed between two adjacent liquid crystal pixel units 160. In other words, each of the flow channels 171 is filled with identical materials to form the liquid crystal pixel units 160, but the present invention is not limited to this and each of the flow channels 171 may be filled with different materials to form the liquid crystal pixel units 160. Additionally, as shown in FIG. 3, the liquid crystal display device 100 may further include an adhesive layer 180 disposed between the second electrode 140 and the liquid crystal pixel units 160. The adhesive layer 180 is employed for combining the first substrate 110 and the second substrate 120. The adhesive layer 180 may include an epoxy material, an acrylic material, or other transparent adhesive materials.

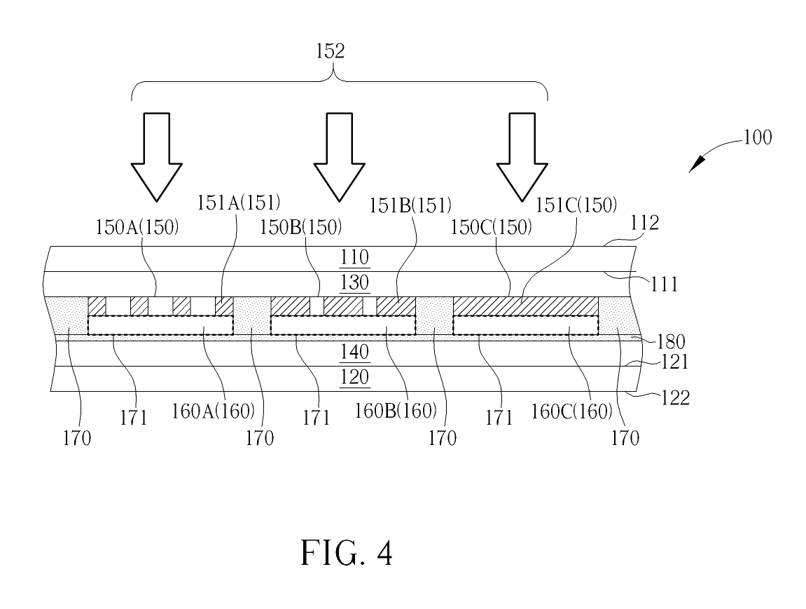

Please refer to FIG. 4. FIG. 4 is a schematic diagram illustrating a method of manufacturing a liquid crystal display device according to a first preferred embodiment of the present invention. As shown in FIG. 4, the transmittance controlling units 150 may be treated with an exposure process 152 for modifying the wavelength ranges of the light reflected by the liquid crystal pixel units 160. More specifically, the wavelength range of the light reflected by the liquid crystal pixel unit 160 may be changed by applying different exposure doses to the liquid crystal pixel unit 160. Two adjacent liquid crystal pixel units 160 may be employed for reflecting light within different wavelength ranges after being treated with the exposure process 152 because the light transmittances of the corresponding transmittance controlling units 150 are different. In other words, according to the transmittance controlling units 150 in this embodiment, the liquid crystal pixel units 160 may be employed for reflecting light within different wavelength ranges after being treated with the exposure process 152 only once. The process may be simplified and the cost of the required photomask may be reduced according to the present invention. Additionally, problems such as the exposure process may be influenced by inadequately controlling distances between the photomask and the substrate, or such as the exposure process may be influenced by the variation in the transmittance of the substrate may then be avoided because the photomasks are replaced by the transmittance controlling units 150, which are disposed in the liquid crystal display device 100. The exposure process 152 may be relatively simplified and the related cost may then be reduced. It is worth noting that each of the transmittance controlling units 150 may include a light-shielding pattern 151. The light-shielding pattern 151 may be made of organic materials, inorganic materials, organic inorganic hybrid materials, or other appropriate materials. The light transmittance of the transmittance controlling unit 150 may be modified by changing the contour or shape of the corresponding light-shielding pattern 151. As mentioned above, the light transmittance of the first transmittance controlling unit 150A, the light transmittance of the second transmittance controlling unit 150B, and the light transmittance of the third transmittance controlling unit 150C are different from each other. The first transmittance controlling unit 150A includes a first light-shielding pattern 151A, the second transmittance controlling unit 150B includes a second light-shielding pattern 151B, and the third transmittance controlling unit 150C includes a third light-shielding pattern 151C. The first light-shielding pattern 151A, the second light-shielding pattern 151B, and the third light-shielding pattern 151 C are different from each other for generating different light transmittance effects. In this embodiment, the light transmittance of the first transmittance controlling unit 150A may be higher than the light transmittance of the second transmittance controlling unit 150B and the light transmittance of the third transmittance controlling unit 150C, the light transmittance of the second transmittance controlling unit 150B may be higher than the light transmittance of the third transmittance controlling unit 150C, and the light transmittance of the third transmittance controlling unit 150C may be substantially equal to zero, but the present invention is not limited to this and the light transmittances of the transmittance controlling units may be further modified as needed. According to the transmittance controlling units 150 with different light transmittance, the first liquid crystal pixel unit 160A, the second liquid crystal pixel unit 160B, and the third liquid crystal pixel unit 160C may be employed to reflect light within different wavelength ranges after being treated with the exposure process 152. For example, the liquid crystal pixel units 160 may be formed by filling the flow channels 171 with a material capable of reflecting light such as blue light. The light transmittance of the first transmittance controlling unit 150A may be the highest and the light transmittance of the third transmittance controlling unit 150C may be substantially equal to zero by modifying the first light-shielding pattern 151A, the second light-shielding pattern 151B, and the third light-shielding pattern 151C. After being treated with the exposure process 152, the first liquid crystal pixel unit 160A, the second liquid crystal pixel unit 160B, and the third liquid crystal pixel unit 160C may be respectively employed to reflect light such as red light, green light, and blue light. In other words, the light transmittances of the transmittance controlling units 150 may be modified according to the material properties of the liquid crystal pixel unit 160 and the exposure dose of the exposure process 152, and the liquid crystal pixel units 160 may then be employed to reflect light within different wavelength ranges by a simplified exposure process. The purpose of full color display effect may then be achieved.

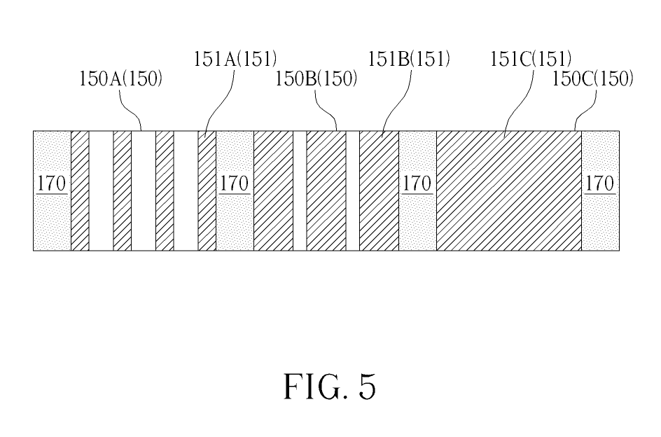

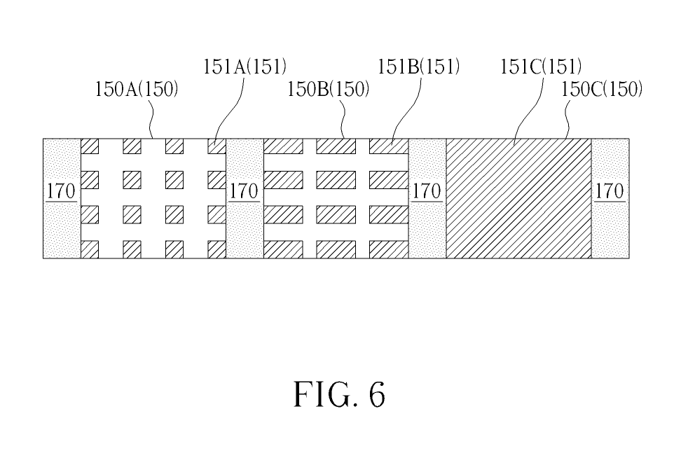

Please refer to FIG. 5, FIG. 6, and FIG. 3. FIG. 5 is a schematic diagram partially illustrating a top view of a liquid crystal display device according to a first preferred embodiment of the present invention. FIG. 6 is a schematic diagram partially illustrating a top view of a liquid crystal display device according to another preferred exemplary embodiment of the present invention. As shown in FIG. 5, the first light-shielding pattern 151A and the second light-shielding pattern 151B may include a plurality of strip patterns. The light transmittance of the first transmittance controlling unit 150A and the light transmittance of the second transmittance controlling unit 150B may be modified by adjusting the width of the strip patterns and the spacing between the strip patterns, but the present invention is not limited to this and the light-shielding pattern 151 may be adjusted in other ways to form different light transmittances. For example, the light transmittances of the transmittance controlling units 150 may also be modified by adjusting the areas of the light-shielding patterns 151. As shown in FIG. 6, in this exemplary embodiment, the first light-shielding pattern 151A and the second light shielding pattern 151B may include a plurality of rectangular patterns, the first transmittance controlling unit 150A and the second transmittance controlling unit 150B may have different light transmittances by adjusting the size of each rectangular pattern and the spacing between the rectangular patterns.

The following description will detail the different embodiments of the liquid crystal display device in the present invention. To simplify the description, the identical components in each of the following embodiments are marked with identical symbols. For making it easier to understand the differences between the embodiments, the following description will detail the dissimilarities among different embodiments and the identical features will not be redundantly described.

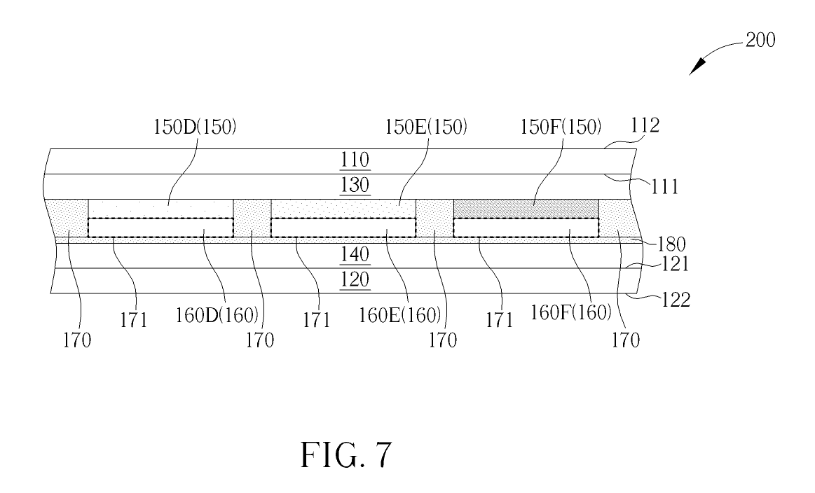

Please refer to FIG. 7. FIG. 7 is a schematic diagram illustrating a liquid crystal display device 200 according to a second preferred embodiment of the present invention. As shown in FIG. 7, the difference between the liquid crystal display device 200 of this embodiment and the liquid crystal display device 100 of the first preferred embodiment is that the transmittance controlling units 150 of this embodiment may include a light-absorbing material. The light transmittances of the transmittance controlling units 150 may be different by adjusting concentrations of the light-absorbing material in each of the transmittance controlling units 150, and the corresponding liquid crystal pixel units 160 may be capable of reflecting light within different wavelength ranges by being treated with an exposure process. More specifically, in this embodiment, the transmittance controlling units 150 include at least one first transmittance controlling unit 150D, at least one second transmittance controlling unit 150E, and at least one third transmittance controlling unit 150F. The liquid crystal pixel units 160 include at least one first liquid crystal pixel unit 160D, at least one second liquid crystal pixel unit 160E, and at least one third liquid crystal pixel unit 160F. The first transmittance controlling unit 150D corresponds to the first liquid crystal pixel unit 160D, the second transmittance controlling unit 150E corresponds to the second liquid crystal pixel unit 160E, and the third transmittance controlling unit 150F corresponds to the third liquid crystal pixel unit 160F. The concentration of the light-absorbing material in the first transmittance controlling unit 150D, the concentration of the light-absorbing material in the second transmittance controlling unit 150E, and the concentration of the light-absorbing material in the third transmittance controlling unit 150F are different with each other. In this embodiment, the concentration of the light-absorbing material in the first transmittance controlling unit 150D is substantially lower than the concentration of the light-absorbing material in the second transmittance controlling unit 150E, and the concentration of the light-absorbing material in the second transmittance controlling unit 150E is substantially lower than the concentration of the light-absorbing material in the third transmittance controlling unit 150F, but not limited thereto. According to the transmittance controlling units 150 with different light transmittance, the first liquid crystal pixel unit 160D, the second liquid crystal pixel unit 160E, and the third liquid crystal pixel unit 160F may be employed to reflect light within different wavelength ranges after being treated with the exposure process. In this embodiment, the transmittance controlling units 150 may include materials such as chromium (Cr), chromium oxide (CrOx), molybdenum silicon (MoSi), or other light-blocking materials. The light transmittance of the transmittance controlling unit 150 may be modified by adjusting the concentrations of the materials mentioned above. Except for the transmittance controlling units 150 of the liquid crystal display device 200, the other components and the material properties of this embodiment are similar to the first preferred embodiment detailed above and will not be redundantly described.

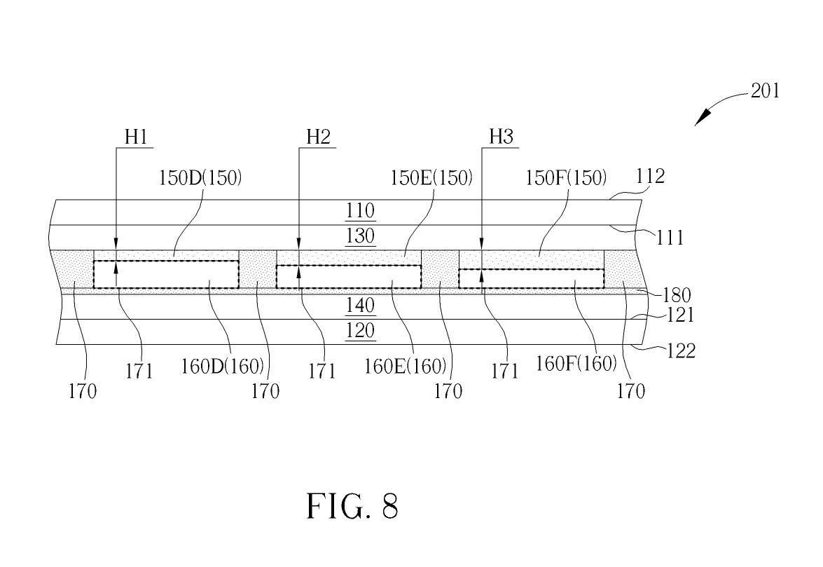

Please refer to FIG. 8. FIG. 8 is a schematic diagram illustrating a liquid crystal display device 201 according to a third preferred embodiment of the present invention. As shown in FIG. 8, the difference between the liquid crystal display device 201 of this embodiment and the liquid crystal display device 200 of the second preferred embodiment is that the concentration of the light-absorbing material in the first transmittance controlling unit 150D, the concentration of the light-absorbing material in the second transmittance controlling unit 150E, and the concentration of the light-absorbing material in the third transmittance controlling unit 150F are substantially the same. The light transmittance differences may be formed by adjusting the thicknesses of the transmittance controlling units 150. More specifically, in this embodiment, a thickness H1 of the first transmittance controlling unit 150D, a thickness H2 of the second transmittance controlling unit 150E, and a thickness H3 of the third transmittance controlling unit 150F may be different from each other. For example, the thickness H1 may be thinner than the thickness H2, and the thickness H2 may be thinner than the thickness H3. The light transmittance of the first transmittance controlling unit 150D may then become higher than the light transmittance of the second transmittance controlling unit 150E, and the light transmittance of the second transmittance controlling unit 150E may then become higher than the light transmittance of the third transmittance controlling unit 150F. According to the transmittance controlling units 150 with different light transmittance, the first liquid crystal pixel unit 160D, the second liquid crystal pixel unit 160E, and the third liquid crystal pixel unit 160F may be employed to reflect light within different wavelength ranges after being treated with the exposure process. Except for the transmittance controlling units 150 of the liquid crystal display device 201, the other components and the material properties of this embodiment are similar to the second preferred embodiment detailed above and will not be redundantly described.

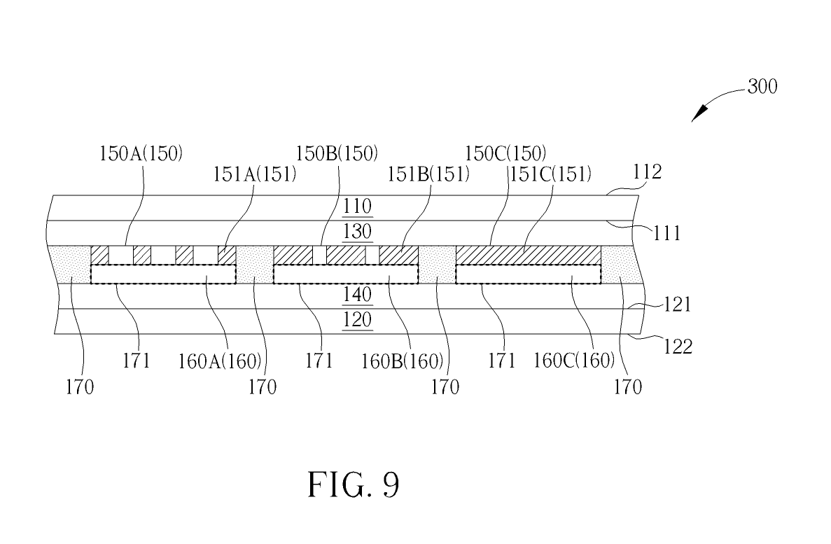

Please refer to FIG. 9. FIG. 9 is a schematic diagram illustrating a liquid crystal display device 300 according to a fourth preferred embodiment of the present invention. As shown in FIG. 9, the difference between the liquid crystal display device 300 of this embodiment and the liquid crystal display device 100 of the first preferred embodiment is that the spacer 170 of this embodiment may include an adhesive material to combine the first substrate 110 and the second substrate 120. Therefore, adhesive layers may not be required in the liquid crystal display device 300 of this embodiment, and the structure and the manufacturing method may then be simplified. The other components and the material properties of this embodiment are similar to the first preferred embodiment detailed above and will not be redundantly described.

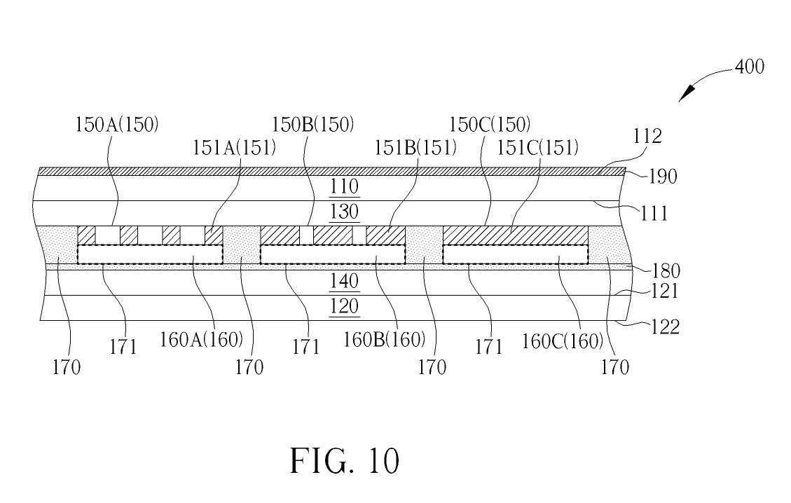

Please refer to FIG. 10. FIG. 10 is a schematic diagram illustrating a liquid crystal display device 400 according to a fifth preferred embodiment of the present invention. As shown in FIG. 10, the difference between the liquid crystal display device 400 of this embodiment and the liquid crystal display device 100 of the first preferred embodiment is that the liquid crystal display device 400 further includes a light-absorbing layer 190 disposed on the first outer surface 112 of the first substrate 110. The light-absorbing layer 190 may be employed to absorb light passing through the liquid crystal pixel units 160, the light may therefore not interfere with the reflective type display effect of the liquid crystal pixel units 160, and the display quality of the liquid crystal display device 400 may then enhanced. Except for the light-absorbing layer 190, the other components and the material properties of this embodiment are similar to the first preferred embodiment detailed above and will not be redundantly described.

To summarize the above descriptions, in the present invention, the transmittance controlling units with different light transmittances are treated with a single exposure process to make the liquid crystal pixel units capable of reflecting different colors. A full color display effect may be accordingly achieved. The transmittance controlling units are disposed in the liquid crystal display device, the cost of the photomask may then be reduced, the exposure process may be simplified, and the performance of the exposure process may be improved. The purposes of cost reduction and quality enhancement may be achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display device, comprising:
a first substrate, the first substrate having a first inner surface and a first outer surface;
a second substrate, disposed oppositely to the first substrate, wherein the second substrate has a second inner surface and a second outer surface, and the second inner surface faces the first inner surface;
a first electrode, disposed on the first inner surface of the first substrate;
a second electrode, disposed on the second inner surface of the second substrate;
a plurality of transmittance controlling units, disposed between the first substrate and the second substrate, wherein at least two of the transmittance controlling units have different light transmittances; and
a plurality of liquid crystal pixel units, disposed between the transmittance controlling units and the second electrode, wherein each of the liquid crystal pixel units is disposed correspondingly to one of the transmittance controlling units, and the liquid crystal pixel units corresponding to the transmittance controlling units with different light transmittances are employed to reflect light within different wavelength ranges.

2. The liquid crystal display device of claim 1, wherein at least one of the transmittance controlling units has a light transmittance substantially equal to zero.

3. The liquid crystal display device of claim 1, wherein the transmittance controlling units comprise at least one first transmittance controlling unit and at least one second transmittance controlling unit, the liquid crystal pixel units comprise at least one first liquid crystal pixel unit and at least one second liquid crystal pixel unit, the first transmittance controlling unit corresponds to the first liquid crystal pixel unit, and the second transmittance controlling unit corresponds to the second liquid crystal pixel unit.

4. The liquid crystal display device of claim 3, wherein a light transmittance of the first transmittance controlling unit is different from a light transmittance of the second transmittance controlling unit, and the first liquid crystal pixel unit and the second crystal pixel unit are employed to reflect light within different wavelength ranges.

5. The liquid crystal display device of claim 4, wherein each of the transmittance controlling units comprises a light-shielding pattern.

6. The liquid crystal display device of claim 5, wherein the first transmittance controlling unit comprises a first light-shielding pattern, the second transmittance controlling unit comprises a second light-shielding pattern, and the first light shielding pattern is different from the second light-shielding pattern.

7. The liquid crystal display device of claim 4, wherein each of the transmittance controlling units comprises a light-absorbing material.

8. The liquid crystal display device of claim 7, wherein a concentration of the light-absorbing material in the first transmittance controlling unit is different from a concentration of the light-absorbing material in the second transmittance controlling unit.

9. The liquid crystal display device of claim 7, wherein a thickness of the first transmittance controlling unit is different from a thickness of the second transmittance controlling unit.

10. The liquid crystal display device of claim 1, further comprising a light-absorbing layer, disposed on the first outer surface of the first substrate.

11. The liquid crystal display device of claim 1, further comprising a plurality of spacers, disposed between the first electrode and the second electrode, wherein each of the spacers is disposed between two adjacent liquid crystal pixel units.

12. The liquid crystal display device of claim 1, further comprising an adhesive layer, disposed between the second electrode and the liquid crystal pixel units.

13. The liquid crystal display device of claim 1, wherein each of the liquid crystal pixel units comprises a liquid crystal monomer, a dye, a chiral reagent, or a polymer compound.

14. The liquid crystal display device of claim 13, wherein the liquid crystal monomer includes a nematic liquid crystal monomer or a cholesteric liquid crystal monomer.
